(19) United States
(12) Patent Application Publication
(10) Pub. No.: US 2016/0148522 A1
(43) Pub. Date: May 26, 2016

(54) ELECTRONIC EDUCATION SYSTEM FOR ENABLING AN INTERACTIVE LEARNING SESSION

(71) Applicant: CLASSWORK CO., Chicago, IL (US)

(72) Inventors: Andrew Harada Rowland, Chicago, IL (US); Peter Do, Chicago, IL (US)

(73) Assignee: CLASSWORK CO., Chicago, IL (US)

(21) Appl. No.: 14/951,526

(22) Filed: Nov. 25, 2015

Related U.S. Application Data
(60) Provisional application No. 62/085,142, filed on Nov. 26, 2014.

(51) Int. Cl. G09B 5/14; H04L 29/08; H04L 29/06; G09B 7/02

(52) U.S. Cl. CPC G09B 5/14; G09B 7/02; H04L 67/1097; H04L 65/4015; H04L 65/601

(57) ABSTRACT

The invention provides an electronic education system for enabling an interactive learning session. The electronic education system includes one or more student devices and an instructor device. A student device includes a student workspace module for enabling a student to interact with one or more assignments pertaining to the interactive learning session. The student device further includes a student query module for enabling a student to request assistance pertaining to one or more queries from an instructor and/or other students. The instructor device includes an instructor workspace module for enabling an instructor to manage the one or more assignments. The instructor device further includes an instructor query module for enabling the instructor to receive the one or more queries and respond to the one or more queries. Further, the instructor device includes a monitoring module that allows the instructor to monitor the interactive learning session in one of a synchronous mode and an asynchronous mode, on the one or more student devices.

### FIELD OF THE INVENTION

The invention generally relates to the field of an electronic education system for enabling an interactive learning session.

### BACKGROUND OF THE INVENTION

With the advent of the information and advancements in the usage of communication technology, there have been developments in conducting interactive online education sessions and media sharing leading to the evolution of E-sharing. E-sharing generally refers to sharing and interacting online through a communication network, anytime and anywhere. E-sharing may be used for applications, such as learning and training involving the delivery of just-in-time information and the receiving of guidance from peers, teachers, lecturers, or instructors. Commonly, two basic types of e-sharing methods are utilized, asynchronous e-sharing and synchronous e-sharing. Asynchronous e-sharing is used when participants are not online at the same time and the sharing is facilitated by media, such as e-mail and discussion boards.

Recent improvements in technology and increasing connectivity and bandwidth capabilities of networks have led to the growing popularity of synchronous e-sharing. Synchronous e-sharing is commonly supported by multimedia capability, such as videoconferencing and instant messaging. Synchronous e-sharing may therefore be considered to be more interactive and social because of a live experience that helps participants to feel like true participants rather than isolated ones. Thus, synchronous e-sharing provides real-time learning and sharing experience and has precluded the need for participants to be in one physical location.

During synchronous e-sharing, for effective real-time and online collaboration, active participation of all the participants is required. Collaboration helps in making the e-sharing experience more interactive and lively and helps in active discussions and resolution of doubts. Various collaboration tools, include, but need not be limited to e-canvases, e-workspaces and electronic whiteboards. However, these collaboration tools need to be utilized more effectively for conducting interactive learning sessions between a teacher and a group of students and between groups of students for enabling the students to receive help from their peers.

Therefore, in light of the above, there is a need for an improved electronic education system for providing interactive learning sessions by effectively using the existing collaboration tools.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a system for enabling an interactive learning session in accordance with an embodiment of the invention.

FIG. 2 illustrates various components within an instructor device and a student device for enabling the interactive learning session in accordance with an embodiment of the invention.

FIG. 3 illustrates an editing tool on an instructor workspace module and a student workspace module in accordance with an embodiment of the invention.

FIG. 4 illustrates an instructor workspace module displaying a list of students and their associated profiles in accordance with an exemplary embodiment of the invention.

FIG. 5 illustrates an instructor query module indicating reception of a query from one or more student devices in accordance with an exemplary embodiment of the invention.

FIG. 6 illustrates a student query module indicating reception of a query from one or more student devices in accordance with an exemplary embodiment of the invention.

FIG. 7 illustrates a student workspace module where a feedback is provided in one of a synchronous mode and an asynchronous mode by a monitoring module of an instructor device in accordance with an exemplary embodiment of the invention.

FIG. 8 illustrates a student workspace module where a feedback is provided in one of a synchronous mode and an asynchronous mode by another student in accordance with an exemplary embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present application.

### DETAILED DESCRIPTION OF THE INVENTION

Before describing in detail embodiments that are in accordance with the invention, it should be observed that the embodiments reside primarily in combinations of method steps and system components related to an electronic education system for enabling an interactive learning session.

Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article or composition that comprises a list of elements does not include only those elements but may include other elements not expressly listed or inherent to such process, method, article or composition. An element proceeded by “comprises . . . a” does not, without more constraints, preclude the existence of additional identical elements in the process, method, article or composition that comprises the element.

Various embodiments of the invention provide an electronic education system for enabling an interactive learning session. The electronic education system includes one or more student devices and an instructor device for enabling the interactive learning session. The one or more student devices and/or the instructor device are configured to initiate an interactive learning session with the other student devices and/or the instructor device. The one or more student devices and the instructor device communicate either in a synchronous mode or in an asynchronous mode.

The one or more student devices include a student workspace module for enabling a student to interact with one or more assignments pertaining to the interactive learning session. The one or more student devices further include a student query module for enabling the student to request assistance pertaining to one or more queries from an instructor and/or other students in one of a synchronous mode and an asynchronous mode. The student query module also enables the student to provide assistance and feedback pertaining to the one or more queries received from other student devices. Moving on, the instructor device includes an instructor workspace module for enabling an instructor to create the one or more assignments. The instructor device further includes an instructor query module for enabling the instructor to receive the one or more queries and respond to the one or more queries received from the one or more student devices. Further, the instructor device includes a monitoring module that allows the instructor to monitor the interactive learning session in one of the synchronous mode and the asynchronous mode on the one or more student devices.

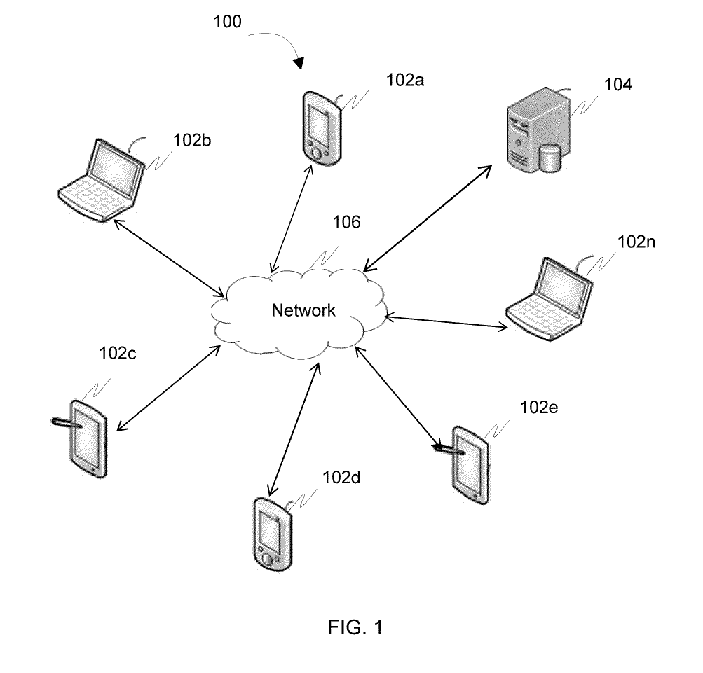

FIG. 1 illustrates an electronic education system 100 for enabling the interactive learning session in accordance with an embodiment of the invention. The interactive learning session can be, but need not be limited to, an education session, a work session, a training session, a conference, a workshop and a meeting.

As illustrated, electronic education system 100 includes an instructor device 102a and one or more student devices 102b-102n for enabling the interactive learning session.

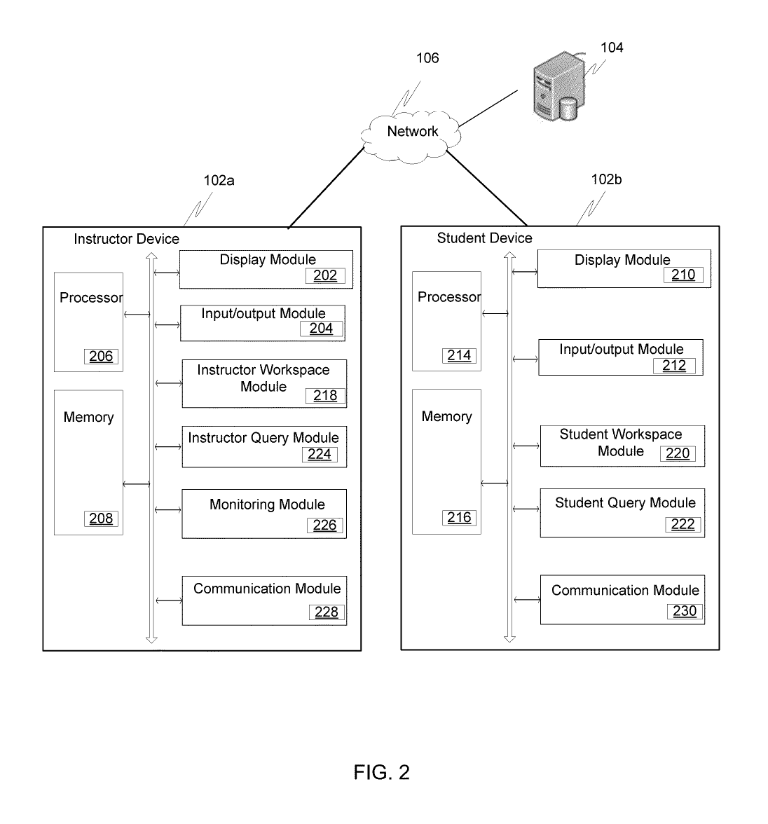

Instructor device 102a and one or more student devices 102b-102n can be, but need not be limited to, a desktop computer, a laptop computer, a server, a tablet computer, a netbook, a cellular phone, a mobile computing device and a touch screen computing device. The various components within instruction device 102a and a student device 102b for enabling the interactive learning session are further described in detail in conjunction with FIG. 2.

Further, instructor device 102a can be managed by at least one of an instructor, a teacher, a coach, a trainer, a manager and a guide. On the other hand, one or more student devices 102b-102n can be managed by at least one of a student, an employee, a teammate and a trainee.

Also, instructor device 102a and one or more student devices 102b-102n interact with each other and with a storage server 104 via a communication network 106. Storage server 104 stores the interactive learning session when either instructor device 102a or one or more student devices 102b-102n are in an offline mode.

Communication network 106 can be, but need not be limited to, a wireless network, wired network, an intranet, a telecom network, an electrical network, a local area network (LAN), a wide area network (WAN), a Virtual Private Network (VPN), an internetwork, a Global Area Network (GAN), the Internet, and such.

The telecom network may utilize different radio communication networks, such as, but not limited to, Code Division Multiple Access (CDMA), Time Division Multiple Access (TDMA), Frequency Division Multiple Access (FDMA), Orthogonal Frequency-Division Multiple Access (OFDMA), Single Carrier Frequency Division Multiple Access (SC-FDMA) and other systems. A CDMA system may implement a radio technology, such as Universal Terrestrial Radio Access (UTRA), and cdma2000. A UTRA network includes variants of CDMA. A cdma2000 standard includes IS-2000, IS-95 and IS-856 standards. A TDMA system may implement a radio technology, such as Global System for Mobile Communications (GSM). An OFDMA system may implement a radio technology, such as Evolved UTRA (E-UTRA), Ultra Mobile Broadband (UMB), IEEE 802.20, IEEE 802.16 (WiMAX), 802.11 (WiFi™), Flash-OFDM®, etc. UTRA and E-UTRA are part of Universal Mobile Telecommunication System (UMTS).

A connection between the different types of communication networks can either be a dedicated connection or a shared connection, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the connection may include a variety of network devices such as, but not limited to, routers, bridges, servers, computing device and storage devices.

Further, communication network 106 can include any medium, usually referred to as a channel, such as, but not limited to, air, a wire, a waveguide, an optical fiber and a wireless link.

FIG. 2 illustrates various components within instruction device 102a and student device 102b for enabling the interactive learning session in accordance with an embodiment of the invention.

As illustrated in FIG. 2, instruction device 102a includes a display module 202 and an input/output module 204. Display module 202 and input/output module 204 are communicatively coupled to each other. Also, display module 202 and input/output module 204 are communicatively coupled to a processor 206 and a memory 208.

Similarly, student device 102b also includes a display module 210 and an input/output module 212. Display module 210 and input/output module 212 are communicatively coupled to each other. Also, display module 210 and input/output module 212 are communicatively coupled to a processor 214 and a memory 216.

Display module 202 and display module 210, can be, but need not be limited to, a touch sensitive display, electronic visual display (e.g., a liquid crystal display (“LCD”) screen, a plasma display panel (“PDP”), a cathode ray tube (“CRT”) display, a light emitting diode (“LED”) display, and/or an organic light emitting diode (“OLED”) display). Touch sensitive display responds to touch-based user input and thus may function as a “touch screen” display. Touch sensitive display may implement one or more touch sensing technologies, such as, but not limited to, resistive touch screen, surface acoustic wave touch screen, surface capacitive touch screen, projected capacitive touch screen, mutual capacitive touch screen, self-capacitive touch screen, infrared touch screen, strain gauge touch screen, optical imaging touch screen, dispersive signal technology touch screen, acoustic pulse recognition touch screen and coded LCD touch screen.

On the other hand, input/output module 204 and input/output module 212 are configured to receive one or more inputs from instructor device 102a and student device 102b respectively. Input/output module 204 and input/output module 212 are then configured to provide an output on display module 202 of instructor device 102a and display module 210 of student device 102b respectively. Input/output module 204 and input/output module 212, can include, but need not be limited to, one or more adapters for outputting data to and/or receiving data from display module 202 and display module 210 respectively (e.g., for providing audio-visual, graphical, and/or textual output), keypad, microphone, mouse, optical reader, scanner, speaker (e.g., for providing audio output), stylus, touch screen and gesture recognition component. Input/output module 204 and input/output module 212 may further include a universal serial bus (USB) port, a serial port, a parallel port, an Institute of Electrical and Electronics Engineers (IEEE) 1394/Fire wire port and a docket port.

In order to initiate the interactive learning session, instructor device 102a and student device 102b also include a sign in module for identifying a type of user for starting the interactive learning session in accordance with an embodiment of the invention. The sign in module may require a username and a password or alternative sign in methods such as a universal group code. The sign in module then provides different user experiences based on the user's access level, hierarchy, and/or user settings. For example, the user can be an admin moderator or a host user level wherein the user has access to control settings for other users at lower access levels.

The host user level can include, but need not be limited to, a teacher, a teacher's assistant, a student leader and a student. The admin moderator can create different levels of access at the host user level which includes temporary users, permanent users, users in a specific group or other type of users.

For example, if an admin moderator such as a teacher/instructor signs in via the sign in module of instructor device 102a, the sign in module provides the teacher with the ability to create sessions. A session may be a set of activities for which other users will interact with an environment set up by the teacher/instructor. The teacher/instructor may be able to set up and organize multiple sessions for different groups of students or time periods. The session may be a classwork or homework assignment that consists of questions, problems, readings or other assignments.

However, it is apparent to a person skilled in the art that a student can also create sessions on a student device and initiate the interactive learning session wherein students can work collaboratively with each other on the one or more assignments.

Once the sign in is complete, the interactive learning session is initiated in instructor device 102a and one or more student devices 102b-102n.

Moving on, instructor device 102a includes an instructor workspace module 218 for enabling an instructor to manage one or more assignments for the interactive learning session. The one or more assignments can be in the form of, but need not be limited to, a lesson on a subject/topic, a tutorial, a test, a text document, a PDF document, a presentation, a chapter of an e-book, a scanned copy of physical material, a video, a screencast, and a spliced interactive video. The instructor can also add one or more learning sessions or alter, reorganize or in other ways change sessions and the content of those sessions.

Instructor workspace module 218, then, transfers the one or more assignments to student device 102b. In another embodiment, instructor workspace module 218 transfers the one or more assignments to storage server 104. Student device 102b, then, retrieves the one or more assignments from storage server 104.

In an embodiment, a student can create one or more assignments and transfers the one or more assignments to other students. Similarly, the student can transfer the one or more assignments to storage server 104 as well. Thereafter, the students work collaboratively the on one or more assignments.

Moving on, on receiving the one or more assignments, student device 102b enables a student to interact with the one or more assignments via a student workspace module 220.

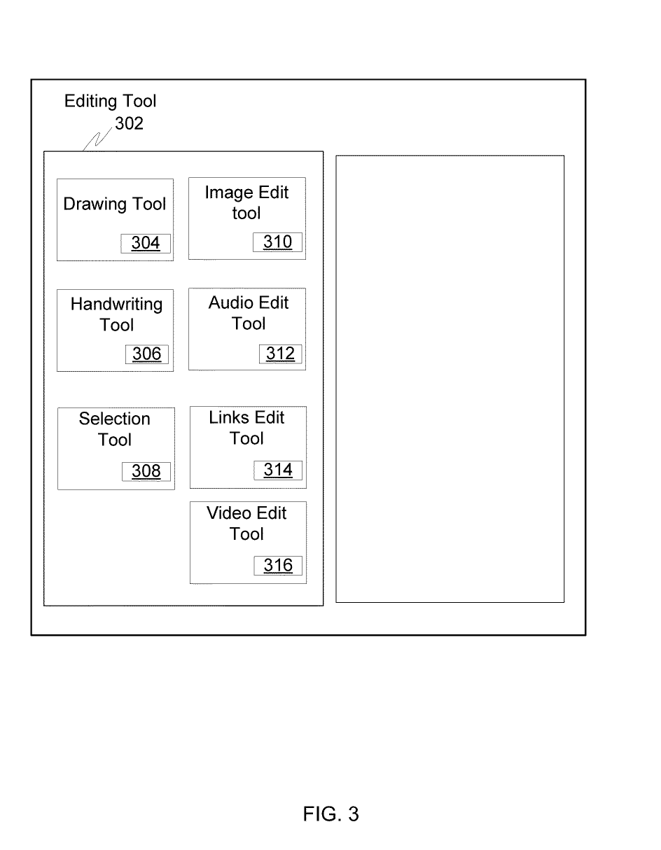

Instructor workspace module 218 and student workspace module 220 can include, but need not be limited to, an e-canvas and an e-workspace. Further, instructor workspace module 218 and student workspace module 220 include an editing tool 302 as illustrated in FIG. 3. Editing tool 302 further includes a drawing tool 304, a handwriting tool 306 and a selection tool 308 to receive inputs from input/output module 204 and input/output module 212 respectively in the form of, but not limited to, handwritten descriptions, annotations, graphical inputs, markup points, digital writing, marking or drawing, typed text, images, audio recordings, video recordings, links to external web content and customized templates comprising multiple forms of media. For example, the instructor and the student can select a thickness of the line while drawing using drawing tool 304. Similarly, a color of the lines or any input entered in instructor workspace module 218 and student workspace module 220 can also be changed by selecting a preferred color through a color palette of drawing tool 304. Options are also provided to draw some standard shapes such as circles, squares, triangles etc. through drawing tool 304.

Further, editing tool 302 facilitates handwriting tool 306 to recognize the handwriting of the instructor and the student and automatically converts pen strokes entered by the instructor and the student pertaining to the one or more assignments on instructor workspace module 218 and student workspace module 220 respectively into digital text that can be read easily. The content entered in instructor workspace module 218 and student workspace module 220 pertaining to the one or more assignments can further be organized under various heading/subheadings Also, editing tool 302 provides the ability to erase the content entered in instructor workspace module 218 and student workspace module 220, instantly or later on using a delete/erase option (not shown). Further, selection tool 308 is used select portions of the content pertaining to the one or more assignments for editing, copying and modifying the content.

Further, editing tool 302 enables a user to provide edits to various types of digital content such as images, audio, links and video using tools such as, but not limited to, an image edit tool 310, an audio edit tool 312, a links edit tool 314 and a video edit tool 316. It should be noted that similar implementations of editing tool 302 are also possible for providing the above mentioned functionalities.

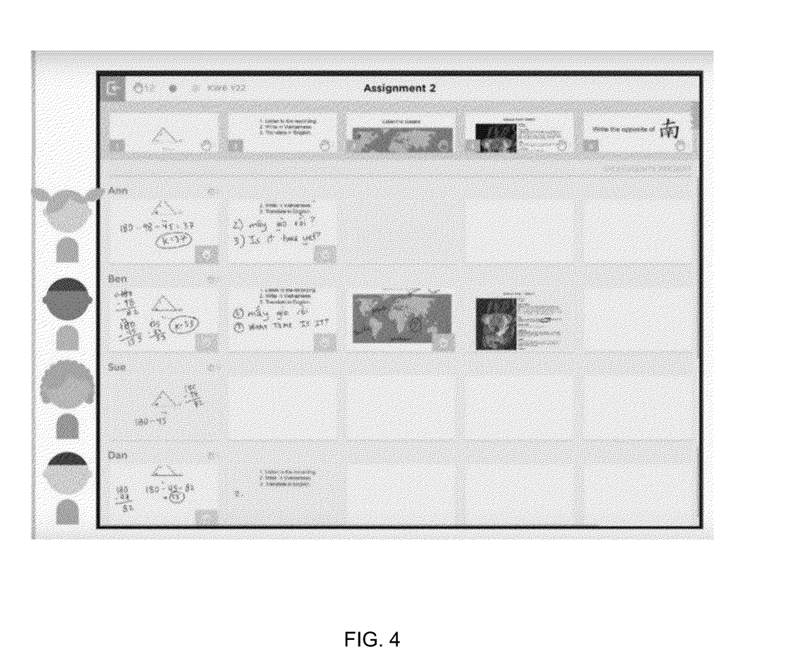

Moving on, instructor workspace module 218 enables the instructor to view a list of students corresponding to one or more student devices 102b-102n. Each entry corresponding to a student in the list of students includes a student profile as illustrated in FIG. 4. The student profile corresponding to each student includes, but need not be limited to, a student name, a student profile icon and a student activity worksheet. The student activity worksheet pertaining to each student includes information pertaining to a student activity and a student progress pertaining to the one or more assignments.

Also, instructor workspace module 218 allows the instructor to select one or more students from the list of students in order to initiate the interactive learning session with the one or more students corresponding to one or more student devices 102b-102n.

Further, instructor workspace module 218 also enables the instructor to arrange the list of students into different groups and associate particular groups with a particular session or assignment. This is done by assigning a class roster for each session or assignment corresponding to a group of students.

Once the interactive learning session is initiated, the one or more students interact with the one or more assignments on their respective student workspace modules on one or more student devices 102b-102n.

In accordance with an embodiment of the invention, consider a student interacting with the one or more assignments on student workspace module 220 of student device 102b.

While working on the one or more assignments, the student may have queries pertaining to the one or more assignments. Student device 102b includes a student query module 222 to enable the student to request assistance from instructor device 102a in one of the synchronous mode and the asynchronous mode for the one or more queries pertaining to the one or more assignments. The student can either click on the ‘raise a query’ or ‘raise a hand’ button to request the transfer of the one or more queries to instructor device 102a.

In an embodiment, the student can send a private signal to the instructor for requesting assistance.

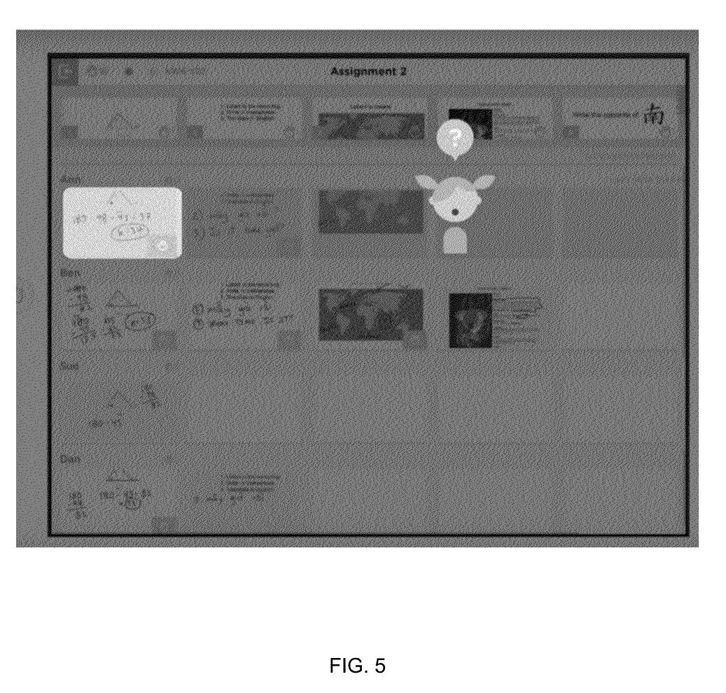

Moving on, instructor device 102a, on the other hand, includes an instructor query module 224 for receiving the one or more queries from student query module 222 of student device 102b. On receiving the one or more queries from student device 102b, instructor query module 224 provides a visual indication to the instructor regarding the reception of the one or more queries from student device 102b such as, but not limited to, “raise a hand” indication as illustrated in FIG. 5.

Instructor query module 224, then, enables the instructor to respond to the one or more queries pertaining to the one or more assignments received from student query module 222 of student device 102b.

In accordance with an embodiment of the invention, instructor query module 224 enables the instructor to share a screen of instructor device 102a with student device 102b. The shared screen of the instructor device 102a is displayed on student workspace module 220. Thus, the instructor is able to interact on instructor workspace module 218 with the one or more assignments in one of the synchronous mode and the asynchronous mode pertaining to the one or more queries for assisting the student.

In accordance with another embodiment of the invention, when an instructor wants to share content created in instructor workspace module 218 with another instructor, the instructor might simply tap a “share” button on instructor workspace module 218 and include another instructor's email address or username. The instructor may also receive monetary compensation from other instructors in exchange for sharing content.

Similarly, student query module 222 also enables the student to request assistance from one or more student devices 102c-102n in one of the synchronous mode and the asynchronous mode for the one or more queries pertaining to the one or more assignments. The student can either click on the ‘raise a query’ or ‘raise a hand’ button to request the transfer of the one or more queries to the one or more student devices 102c-102n.

In an embodiment, the student can send a private signal to one or more other students for requesting assistance.

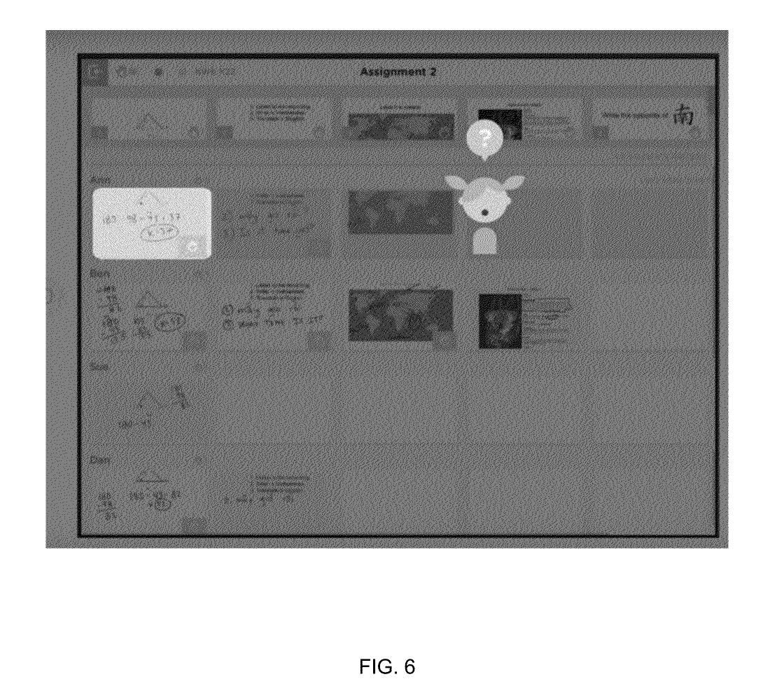

Student query module 222 also enables the student of student device 102b to respond to the one or more queries raised by the one or more students of one or more student devices 102c-102n as illustrated in FIG. 6.

Further, while receiving/responding to the one or more queries, student query module 222 shares a screen of student device 102b with instructor device 102a or with one or more student devices 102c-102n.

On receiving the response to the one or more queries, student query module 222 informs the student of whether the student has successfully learned or performed something pertaining to the response and a current activity of the student in student workspace module 220. For example, student query module 222 displays messages such as, but not limited to, “good to go”, “you can move on” or “you need to keep trying this until you get it” in response to the student receiving the assistance from instructor device 102a or one or more student devices 102c-102n.

In another embodiment, instructor device 102a enables the instructor to choose one or more students of one or more student devices 102b-102n to whom the instructor delegates various statuses that bestow more access and abilities. For example, instructor device 102a chooses student device 102b as a “student helper”. Upon being granted this status, student device 102b would be prompted by calls for help or assistance from other student devices 102c-102n. Student device 102b might also see notifications requesting help on a specific student's worksheets. For example, if a student helper of student device 102b tapped the notification, the work of another student would appear on a student workspace module of the student helper. The student helper could then provide feedback or assistance in a similar way as the instructor.

Moving on, instructor device 102a also includes a monitoring module 226 for monitoring the interactive learning session of the student on student workspace module 220 in one of the synchronous mode and the asynchronous mode corresponding to the one or more assignments. Monitoring module 226 enables the instructor to view, in one of the synchronous mode and the asynchronous mode, the progress of the student pertaining to the one or more assignments on student workspace module 220. Further, monitoring module 226 enables the instructor to view a generic summary of the student's progress in the student activity worksheet. The summary may be displayed in the form of a grid, spreadsheet or any other method of organizing. The list of students may then be scrolled or panned in any 2-dimensional direction (up, down, left, right, diagonal, etc.). The list may also be searched or sorted based on a number of filters. In this view, the instructor sees the most basic information about a student's work and progress, such as a check mark on the one or more assignments to show that the student has worked on the one or more assignments and a missed check mark on the one or more assignments to indicate that the student has not attempted the one or more assignments.

The instructor may then zoom in using appropriate gestures, such as pinching or separating two fingers via input/output module 204, to view a more detailed grid that displays further details of the student's results. This view may include the same content as before, but in greater detail. For example, if the previous grid displayed only a box with a check mark, this view would also show a picture as a small thumbnail of the student's current work. The content, boxes, and pictures of this view might also be scrolled or panned in any 2-dimensional direction (up, down, left, right, diagonal, etc.). Further, the scrollable grid may include a chronologically-arranged listing of the student's work results, question answers, drawings, etc.

Further, monitoring module 226 enables the instructor to explore the student's results in a more detailed view. The more detailed view may display every detail of content created and actions performed by the students. The instructor views this content in one of the synchronous mode and the asynchronous mode at the moment it is being created or after a time when the student is already done performing actions, creating content or answering questions pertaining to the one or more assignments in student workspace module 220.

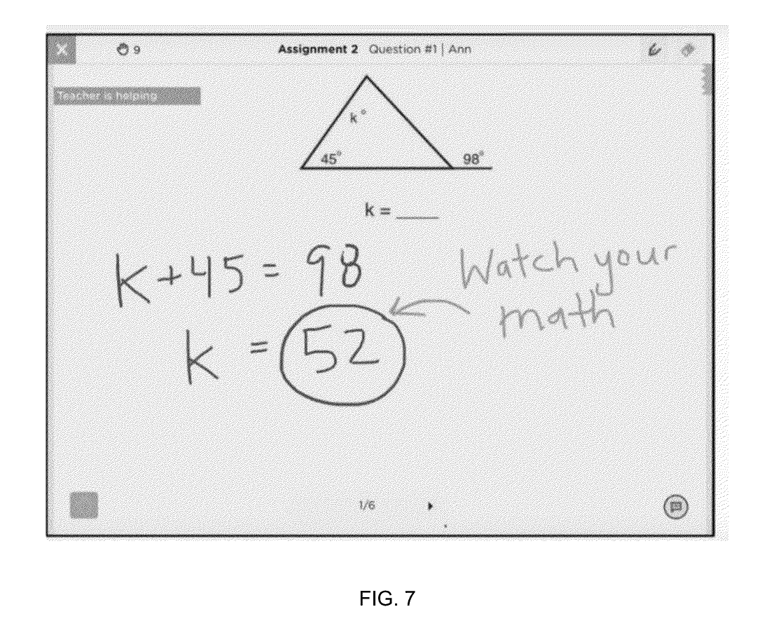

In response to the monitoring, the instructor can provide feedback either synchronously or asynchronously on student workspace module 220 for guiding the student through the one or more assignments as illustrated in FIG. 7. The feedback can be in the form of, but need not be limited to, a comment, a grade/score, an improvement suggestion, a solution and a correction pertaining to the one or more assignments.

For example, the instructor may choose to provide a response or feedback to a student on a result pertaining to an assignment. The instructor can provide a handwritten note, type, speak, or draw a note to the student. In another aspect, the instructor may tap a button that automatically provides predefined feedback to the student. The button for automatically providing the predefined feedback can have a generic message associated with it that the student can see upon a tap. The instructor can also customize the pre-defined feedback based on a current situation. For example, the instructor may notice that on a given day, many students need only certain types of feedback, 1) “Remember to distribute x” 2) “You forgot a negative sign” or 3) “Watch your Math”. Thus, the instructor types preloaded messages and when panning through each student's work, taps a button to send off the appropriate message to the appropriate student.

Further, monitoring module 226 overlays the feedback directly over the one or more assignments in student workspace module 220. As a result students may respond, fix the work or take other actions in response to the feedback.

Thus, the instructor is able to provide guidance and feedback to the student in one of the synchronous mode and the asynchronous mode for enabling the student to complete the one or more assignments pertaining to the interactive learning session.

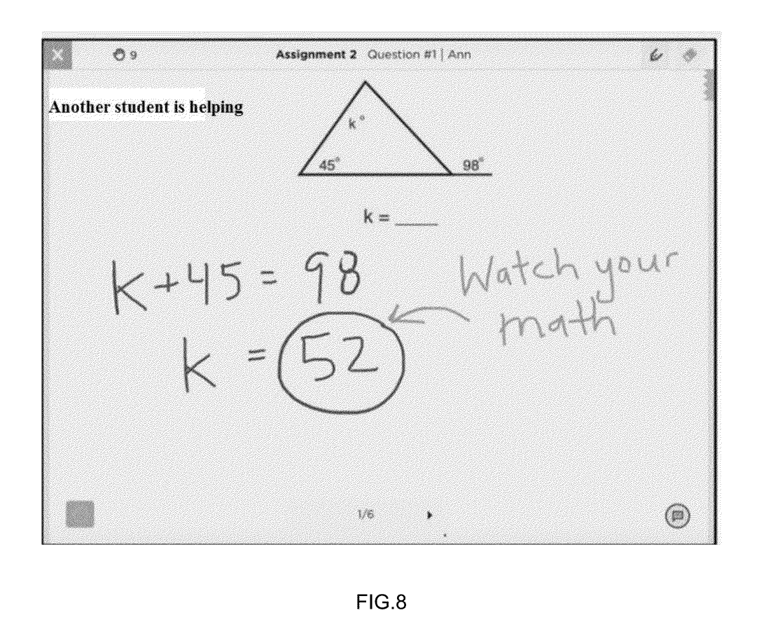

In accordance with another embodiment, student query module 222 of student device 102b enables a student to provide feedback either synchronously or asynchronously on a student workspace module pertaining to one or more student devices 102c-102n for guiding the student through the one or more assignments as illustrated in FIG. 8.

Moving on, instructor device 102a also includes a communication module 228 for enabling communication in one of the synchronous mode and the asynchronous mode between instructor device 102a and one or more student devices 102b-102n.

Similarly, student device 102b also includes a communication module 230 for enabling communication in one of the synchronous mode and the asynchronous mode between student device 102b, instructor device 102a and one or more student devices 102c-102n.

In an asynchronous mode, communication module 230 of student device 102b enables the student to receive a response asynchronously and remotely. Consider a scenario where a student may work on a question after school hours and then close the application. A remote instructor might then provide a response or feedback on the student's work. The student then receives a notification or text message on the student's device that indicates that the instructor has provided a response. The student would then be able to take action by reviewing and fixing the work. The student can also access any information pertaining to the one or more assignments from storage server 104 in asynchronous mode.

The system, as described in the invention or any of its components may be embodied in the form of a computing device. The computing device can be, for example, but not limited to, a general-purpose computer, a programmed microprocessor, a micro-controller, a peripheral integrated circuit element, and other devices or arrangements of devices, which are capable of implementing the steps that constitute the method of the invention. The computing device includes a processor, a memory, a nonvolatile data storage, a display, and a user interface.

In the foregoing specification, specific embodiments of the present application have been described. However, one of ordinary skill in the art appreciates that various modifications and changes can be made without departing from the scope of the present application as set forth in the claims below. Accordingly, the specification is to be regarded in an illustrative rather than a restrictive sense, and all such modifications are intended to be included within the scope of the present application. The benefits, advantages, solutions to problems, and any element(s) that may cause any benefit, advantage, or solution to occur or become more pronounced are not to be construed as a critical, required, or essential features or elements of any or all the claims. The present application is defined solely by the appended claims including any amendments made during the pendency of this application and all equivalents of those claims as issued.

What is claimed is:

1. An electronic education system for enabling an interactive learning session, the electronic education system comprising:
a. at least one student device, wherein a student device comprises:
i. a student workspace module, wherein the student workspace module facilitates a student to interact with at least one assignment, wherein an assignment is one of a lesson on a subject/topic, a tutorial, a test, a text document, a PDF document, a presentation, a chapter of an e-book, a scanned copy of physical material and a video;
ii. a student query module, wherein the student query module is configured to:
enable a student to request assistance in one of a synchronous mode and an asynchronous mode for at least one query on the at least one assignment from at least one of an instructor and at least one student;
enable the student to receive assistance/response from at least one of the instructor and the at least one student in response to requesting assistance;
b. an instructor device, wherein the instructor device comprises:
i. an instructor workspace module, wherein the instructor workspace module is configured to facilitate an instructor to manage the at least one assignment for the interactive learning session;
ii. an instructor query module, wherein the instructor query module is configured to:
receive at least one query from the at least one student device;
facilitate the instructor to respond to the at least one query; and
c. a monitoring module, wherein the monitoring module is configured to facilitate the instructor to monitor the interactive learning session in one of a synchronous mode and an asynchronous mode on the at least one student device.

2. The electronic education system of claim 1, wherein the instructor workspace module is further configured to transfer the at least one assignment to a storage server.

3. The electronic education system of claim 2, wherein the student workspace module is further configured to share the at least one assignment with one or more of the at least one student device and the storage server.

4. The electronic education system of claim 2, wherein the student workspace module is configured to fetch the at least one assignment from the storage server.

5. The electronic education system of claim 1, wherein the instructor workspace module and the student workspace module comprise at least one of an e-canvas and an e-whiteboard.

6. The electronic education system of claim 1, wherein the instructor workspace module and the student workspace module comprise an editing tool for facilitating interaction with the at least one assignment, wherein an instructor can create, modify and edit the assignment at the instructor workspace module.

7. The electronic education system of claim 6, wherein the editing tool is configured to receive an input pertaining to the at least one assignment through at least one of a stylus, a button and a touch gesture.

8. The electronic education system of claim 5, wherein an input includes at least one of a handwritten annotation, a graphical input and a markup point.

9. The electronic education system of claim 1, wherein the instructor workspace module is further configured to enable the instructor to view a list of students, wherein each entry corresponding to a student in the list of students comprises a student profile of the student.

10. The electronic education system of claim 9, wherein a student profile comprises at least one of a student name, a student profile icon and a student activity worksheet.

11. The electronic education system of claim 10, wherein the instructor workspace module is configured to enable the instructor to select at least one student from the list of students for initiating the interactive learning session with the at least one student.

12. The electronic education system of claim 1, wherein the instructor query module is further configured to share a screen of the instructor device while responding to the at least one query, wherein, the instructor interacts, in one of the synchronous mode and the asynchronous mode, on the instructor workspace module, with the at least one assignment corresponding to the at least one query for assisting at least one student.

13. The electronic education system of claim 1, wherein the monitoring module is further configured to enable the instructor to:
view progress of a student in one of the synchronous mode and the asynchronous mode pertaining to the at least one assignment on the student workspace module; and
provide a feedback in one of the synchronous mode and the asynchronous mode on the student workspace module for guiding the student through the at least one assignment.

14. The electronic education system of claim 13, wherein a feedback comprises at least one of a comment, a grade/score, an improvement suggestion, a solution and a correction.

15. The electronic education system of claim 14, wherein the monitoring module is configured to overlay the feedback on the at least one assignment on the student workspace module.

16. The electronic education system of claim 1, wherein the student query module is further configured to facilitate a student to provide assistance/response to the at least one query raised by the at least one student.

17. The electronic education system of claim 1, wherein the student query module is further configured to share a screen of the student device with one of the instructor device and the at least one student device for receiving assistance/response from at least one of the instructor and the at least one student.

18. The electronic system of claim 1 further comprises a communication module, wherein communication module enables synchronous communication between the instructor device and the at least one student device, wherein the synchronous communication comprises one of a voice, text, data, image and body language including gestures using a variety of means, such as touch screen for writing or drawing images by hand, video conferencing for body language, voice file for recording voice, text messaging and annotation.
